(19) United States
(12) Patent Application Publication
(10) Pub. No.: US 2015/0142628 A1
(43) Pub. Date: May 21, 2015

(54) DETECTING STRUCTURED TRANSACTIONS

(71) Applicant: Bank of America Corporation, Charlotte, NC (US)

(72) Inventors: Carl Suplee, Hunterville, NC (US); Cameron Blake Hughes, Charlotte, NC (US); Jun Zhou, Charlotte, NC (US); Cindy Yuki Kasahara-Foster, Davidson, NC (US); Xiaowei Ying, Charlotte, NC (US)

(73) Assignee: Bank of America Corporation, Charlotte, NC (US)

(21) Appl. No.: 14/085,484

(22) Filed: Nov. 20, 2013

(51) Int. Cl. G06Q 40/02

(52) U.S. Cl. CPC G06Q 40/02
USPC 705/35

(57) ABSTRACT

In some embodiments, a system comprises an interface and one or more processors. The interface receives a potential alert associated with a transaction between a first party and a second party. The processors determine a first subset of same party transactions transacted between the parties during an alert period and a second subset of same party transactions transacted between the parties during a review period. The processors apply a plurality of weighting factors to the first subset of transactions and the second subset of transactions to determine a risk level. The interface communicates the risk level.

### TECHNICAL FIELD OF THE INVENTION

This invention relates generally to monitoring techniques, and more particularly to detecting structured transactions.

### BACKGROUND

A financial institution processes deposit, withdrawal, and/or other transactions initiated by its customers. In certain circumstances, the financial institution may be required to report the transaction(s) to the government. For example, laws may require the financial institution to file a currency transaction report (CTR) if a transaction (or a series of related transactions) exceeds a set dollar amount, such as $10,000 per day. A customer may attempt to avoid having a CRT filed by structuring a series of transactions to fall below the set dollar amount. For example, the customer may conduct related transactions in the amount of $9,000 each over the course of several consecutive days. If detected, the financial institution may report these transactions as suspicious.

### SUMMARY

According to embodiments of the present disclosure, disadvantages and problems associated with detecting structured transactions may be reduced or eliminated.

In some embodiments, a system comprises an interface and one or more processors. The interface receives a potential alert associated with a transaction between a first party and a second party. The processors determine a first subset of same party transactions transacted between the parties during an alert period and a second subset of same party transactions transacted between the parties during a review period. The processors apply a plurality of weighting factors to the first subset of transactions and the second subset of transactions to determine a risk level. The interface communicates the risk level.

Certain embodiments of the present disclosure may provide one or more technical advantages. A technical advantage of one embodiment includes detecting structured transactions accurately and efficiently. For example, certain embodiments may apply weighting factors that increase a risk level associated with transactions and/or parties corresponding to patterns of activity that suggest an intent to structure transactions. One or more other technical advantages may be readily apparent to those skilled in the art from the figures, descriptions, and claims included herein.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates a block diagram of a system for detecting structured transactions;

FIG. 2 illustrates an example flowchart for detecting structured transactions; and

FIG. 3 illustrates an example of a transaction history to which weighting factors may be applied in order to detect structured transactions.

### DETAILED DESCRIPTION OF THE DRAWINGS

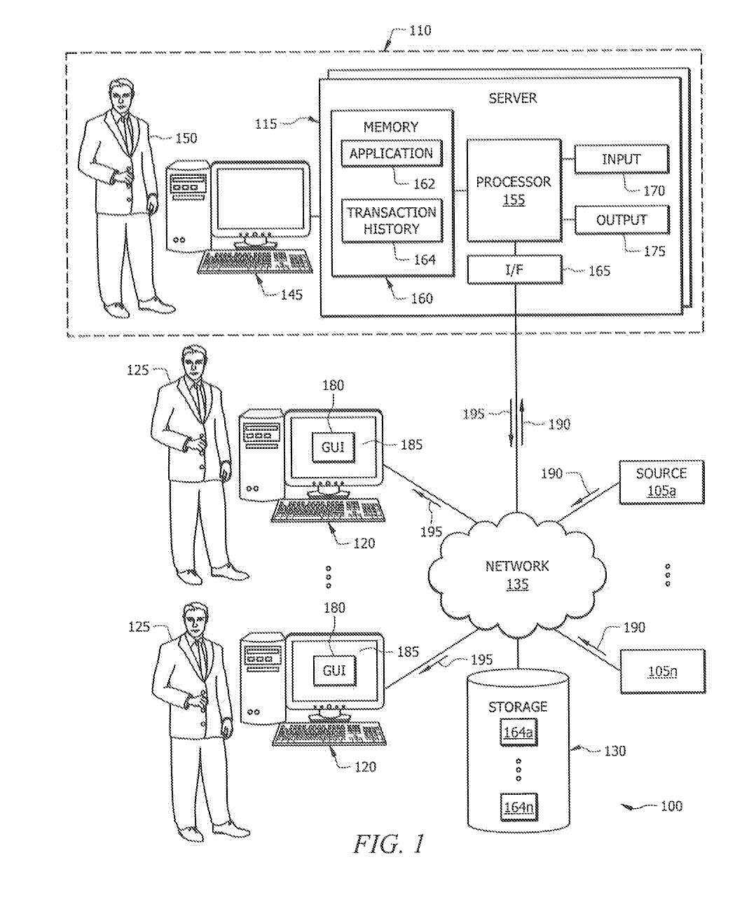

Embodiments of the present invention and its advantages are best understood by referring to FIGS. 1 through 3 of the drawings, like numerals being used for like and corresponding parts of the various drawings.

A financial institution processes deposit, withdrawal, and/or other transactions initiated by its customers. In certain circumstances, the financial institution may be required to report the transaction(s) to the government. For example, laws may require the financial institution to file a currency transaction report (CTR) if a transaction (or a series of related transactions) exceeds a set dollar amount, such as $10,000 per day. A customer may attempt to avoid having a CRT filed by structuring a series of transactions to fall below the set dollar amount. For example, the customer may conduct related transactions in the amount of $9,000 each over the course of several consecutive days. If detected, the financial institution may report these transactions as suspicious.

Conventional techniques for detecting structured transactions tend to be over-inclusive in that they identify not only high risk transactions, but also low risk transactions. For example, conventional techniques may identify any transaction in an amount between $9,000 and $9,999 as suspicious. However, some of these transactions may be low risk. As an example, a business may average approximately $10,000 in sales per day. Each day, the business may deposit the money from the sales. The business may deposit more than $10,000 on good sales days and slightly less than $10,000 on slow sales days. On the days that the business deposits slightly less than $10,000, the reason is that it had low sales that day and not that it intends to structure transactions to avoid reporting requirements. Thus, the transaction is low risk such that reporting the transaction as suspicious unnecessarily burdens resources responsible for investigating suspicious activity.

To address this and other problems, embodiments of the present invention allow for determining a risk level for a transaction and/or a party to the transaction. To determine the risk level, weighting factors may be applied so that increased risk is assigned to patterns of activity that are consistent with intent to structure transactions. The risk level may be used to efficiently detect structured transactions.

FIG. 1 illustrates an example block diagram of a system 100 for detecting structured transactions. System 100 may include one or more sources 105, an enterprise 110 comprising one or more servers 115, one or more clients 120 associated with one or more users 125, and a network storage device 130. Sources 105, enterprise 110, servers 115, clients 120, and network storage device 130 may be communicatively coupled by a network 135. In general, source 105 may provide a server 115 of enterprise 110 with a potential alert 190 that is associated with a transaction. Server 115 analyzes the potential alert 190 to determine a risk level 195. In some embodiments, risk level 195 may indicate a likelihood that the transaction has been structured to avoid reporting requirements. Server 115 provides risk level 195 to users 125 via client 120.

Client 120 may refer to any device that enables user 125 to interact with server 115. In some embodiments, client 120 may include a computer, workstation, telephone, Internet browser, electronic notebook, Personal Digital Assistant (PDA), pager, or any other suitable device (wireless, wireline, or otherwise), component, or element capable of receiving, processing, storing, and/or communicating information with other components of system 100. Client 120 may also comprise any suitable user interface such as a display 185, microphone, keyboard, or any other appropriate terminal equipment usable by a user 125. It will be understood that system 100 may comprise any number and combination of clients 120. User 125 utilizes client 120 to interact with server 115 to receive risk level 195, as described below. In some embodiments, user 125 may be an employee of a financial institution, an investigative business, or a governmental entity that monitors transactions to detect transaction structuring.

In some embodiments, client 120 may include a graphical user interface (GUI) 180. GUI 180 is generally operable to tailor and filter data entered by and presented to user 125. GUI 180 may provide user 125 with an efficient and user-friendly presentation of potential alert 190 and/or risk level 195. GUI 180 may comprise a plurality of displays having interactive fields, pull-down lists, and buttons operated by user 125. GUI 180 may include multiple levels of abstraction including groupings and boundaries. It should be understood that the term GUI 180 may be used in the singular or in the plural to describe one or more GUIs 180 and each of the displays of a particular GUI 180.

In some embodiments, network storage device 130 may refer to any suitable device communicatively coupled to network 135 and capable of storing and facilitating retrieval of data and/or instructions. Examples of network storage device 130 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile, non-transitory computer-readable memory devices that store one or more files, lists, tables, or other arrangements of information. Network storage device 130 may store any data and/or instructions utilized by server 115. In the illustrated embodiment, network storage device 130 stores transaction history 164. Transaction history 164 may include data describing previous transactions by the same party (or parties) associated with potential alert 190. For each transaction, transaction history 164 may include a transaction number, account number, originating party identifier, beneficiary party identifier, transaction date, transaction location, transaction method (e.g., bank branch, ATM, online, wire, cash, etc.), transaction type (e.g., deposit, withdrawal), dollar amount, report indicator that indicates whether or not a report was filed on the transaction, and/or other suitable information. Transaction history 164 may be analyzed to determine whether the party (or parties) has demonstrated a pattern of activity consistent with transaction structuring.

In certain embodiments, network 135 may refer to any interconnecting system capable of transmitting audio, video, signals, data, messages, or any combination of the preceding. Network 135 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, enterprise 110 may refer to a financial institution such as a bank and may include one or more servers 115, an administrator workstation 145, and an administrator 150. In some embodiments, server 115 may refer to any suitable combination of hardware and/or software implemented in one or more modules to process data and provide the described functions and operations. In some embodiments, the functions and operations described herein may be performed by a pool of servers 115. In some embodiments, server 115 may include, for example, a mainframe, server, host computer, workstation, web server, file server, a personal computer such as a laptop, or any other suitable device operable to process data. In some embodiments, server 115 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems.

In general, server 115 determines the parties to a transaction indicated by potential alert 190, applies weighting factors based on other transactions associated with one or both parties, determines risk level 195 according to the weighting factors, and provides risk level 195 to users 125. In some embodiments, servers 115 may include a processor 155, server memory 160, an interface 165, an input 170, and an output 175. Server memory 160 may refer to any suitable device capable of storing and facilitating retrieval of data and/or instructions. Examples of server memory 160 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile, non-transitory computer-readable memory devices that store one or more files, lists, tables, or other arrangements of information. Although FIG. 1 illustrates server memory 160 as internal to server 115, it should be understood that server memory 160 may be internal or external to server 115, depending on particular implementations. Also, server memory 160 may be separate from or integral to other memory devices to achieve any suitable arrangement of memory devices for use in system 100.

Server memory 160 is generally operable to store an application 162 and transaction history 164. Application 162 generally refers to logic, rules, algorithms, code, tables, and/or other suitable instructions for performing the described functions and operations. In some embodiments, application 162 facilitates determining risk level 195 and communicating risk level 195 to users 125.

Server memory 160 communicatively couples to processor 155. Processor 155 is generally operable to execute application 162 stored in server memory 160 to provide risk level 195 according to the disclosure. Processor 155 may comprise any suitable combination of hardware and software implemented in one or more modules to execute instructions and manipulate data to perform the described functions for servers 115. In some embodiments, processor 155 may include, for example, one or more computers, one or more central processing units (CPUs), one or more microprocessors, one or more applications, and/or other logic.

In some embodiments, communication interface 165 (I/F) is communicatively coupled to processor 155 and may refer to any suitable device operable to receive input for server 115, send output from server 115, perform suitable processing of the input or output or both, communicate to other devices, or any combination of the preceding. Communication interface 165 may include appropriate hardware (e.g. modem, network interface card, etc.) and software, including protocol conversion and data processing capabilities, to communicate through network 135 or other communication system that allows server 115 to communicate to other devices. Communication interface 165 may include any suitable software operable to access data from various devices such as clients 120 and/or network storage device 130. Communication interface 165 may also include any suitable software operable to transmit data to various devices such as clients 120 and/or network storage device 130. Communication interface 165 may include one or more ports, conversion software, or both. In general, communication interface 165 receives potential alert 190 from source 105 and transmits risk level 195 to clients 120.

In some embodiments, input device 170 may refer to any suitable device operable to input, select, and/or manipulate various data and information. Input device 170 may include, for example, a keyboard, mouse, graphics tablet, joystick, light pen, microphone, scanner, or other suitable input device. Output device 175 may refer to any suitable device operable for displaying information to a user. Output device 175 may include, for example, a video display, a printer, a plotter, or other suitable output device.

In general, administrator 150 may interact with server 115 using an administrator workstation 145. In some embodiments, administrator workstation 145 may be communicatively coupled to server 115 and may refer to any suitable computing system, workstation, personal computer such as a laptop, or any other device operable to process data. In certain embodiments, an administrator 150 may utilize administrator workstation 145 to manage server 115 and any of the data stored in server memory 160 and/or network storage device 130.

In operation, application 162, upon execution by processor 155, facilitates determining risk level 195 and offers risk level 195 to users 125. Risk level 195 indicates a likelihood that a transaction is suspicious and/or that a party to the transaction has structured one or more transactions (e.g., to avoid governmental reporting requirements). Risk level 195 may be determined according to one or more weighting factors. In some embodiments, the weighting factors may increase risk level 195 if the transaction is part of a pattern of activity consistent with transaction structuring. Conversely, the weighting factors may decrease risk level 195 if the transaction is not part of a pattern of activity consistent with transaction structuring. As used herein, decreasing risk level 195 may refer to lowering risk level 195 or keeping risk level 195 the same (i.e., not increasing risk level 195).

To provide risk level 195, application 162 may first receive potential alert 190 from source 105. Source 105 may monitor transactions and generate potential alert 190 comprising transaction data, such as a transaction number, account number, originating party identifier, beneficiary party identifier, transaction date, transaction location, transaction method (e.g., bank branch, ATM, online, wire, cash, etc.), transaction type (e.g., deposit, withdrawal), dollar amount, and/or other suitable information. In some embodiments, source 105 may generate potential alert 190 only for transactions that appear suspicious based on some preliminary criteria, such as identity of the parties to the transaction, the dollar amount (e.g., greater than a de minimis amount but less than a reporting requirement), and/or other preliminary criteria. In alternative embodiments, source 105 may generate potential alert 190 to provide transaction data for each transaction transacted by system 100. Although FIG. 1 illustrates source 105 as external to enterprise 110, it should be understood that source 105 may be internal or external to enterprise 110, depending on particular implementations.

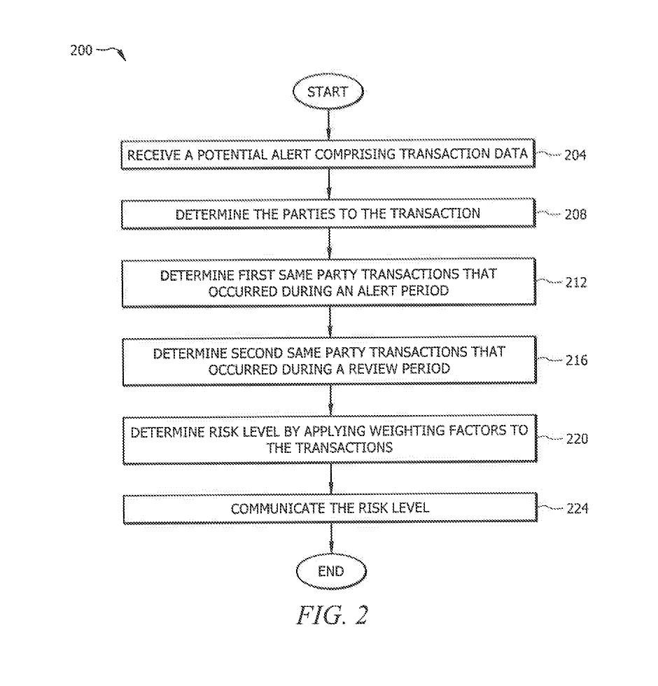

Once application 162 receives potential alert 190, application 162 may determine risk level 195. In general application 162 may determine a party (or parties) associated with potential alert 190. For example, application 162 may determine party information based on a party identifier, such as a name, account number, social security number, or other identifier indicated by potential alert 190. Application 162 may then retrieve transaction history 164 associated with the same party. Application 162 may apply weighting factors based on transaction history 164 to determine risk level 195. Application 162 may then communicate risk level 195 to user 125. FIG. 2 below provides a detailed example of a method that application 162 may perform to determine risk level 195.

FIG. 2 illustrates an example of a method 200 for determining a risk level 195. Risk level 195 may be used to facilitate the detection of suspicious activity, such as transaction structuring. The method begins at step 204 by receiving a potential alert 190 comprising transaction data, such as a transaction number, account number, originating party identifier, beneficiary party identifier, transaction date, transaction location, transaction method (e.g., bank branch, ATM, online, wire, cash, etc.), transaction type (e.g., deposit, withdrawal), dollar amount, and/or other suitable information.

In some embodiments, the method may perform a preliminary assessment to check whether or not it is necessary to determine risk level 195 for the transaction indicated by potential alert 190. As an example, the preliminary assessment may decide it is not necessary to determine risk level 195 if the dollar amount of the transaction is high enough to trigger a reporting requirement. That is, the filing of a report suggests that the parties did not intend to avoid the reporting requirement. As another example, the preliminary assessment may decide that it is not necessary to determine risk level 195 if the dollar amount is less than a minimum monetary amount. The minimum monetary amount may be set relative to the reporting limit in order to generate potential alerts for transactions with a higher likelihood of being structured (e.g., transactions just under the reporting limit) without generating unnecessary potential alerts for transactions that are less likely to be structured (e.g., transactions well below the reporting limit). In some embodiments, the minimum monetary amount to proceed with determining risk level 195 may be set to 10%, 20%, 30%, 40%, 50%, or other suitable percentage of the reporting requirement. For example, if the reporting requirement is $10,000, the minimum monetary amount may be set to $5,000, which is 50% of the reporting requirement.

If the method decides to determine risk level 195 for the transaction, the method proceeds to step 208. At step 208, the method determines a first party (Party A) and a second party (Party B) to the transaction associated with potential alert 190. A party may refer to a person, an entity, an account, or any other party that provides or receives finances through a transaction.

At step 212, the method determines a first subset of same party transactions. The first subset of same party transactions may include some or all of the transactions between the first party and the second party during a alert period. The alert period may refer to a period of time during which the transaction indicated by potential alert 190 is likely to have been structured with other transactions. For example, a party intending to structure transactions may be likely to make three separate $9,000 transactions on three consecutive days. Thus, setting the alert period to monitor transactions occurring over at least three days could assess the three transactions to determine if they demonstrate a pattern of activity consistent with transaction structuring. By contrast, a party intending to structure transactions may be unlikely to wait a prolonged period of time, such as one year, between transacting each installment of the structured transaction. Thus, the alert period may be less than 1 year to limit the number of low risk/unrelated transactions analyzed by the method. Any suitable alert period may be used, such as 2 days, 3 days, 5 days, 1 week, 1 month, or other time period. The alert period may be set to monitor transactions occurring before and/or after the transaction indicated by potential alert 190.

The method determines a second subset of same party transactions in step 216. The second subset of same party transactions may include some or all of the transactions by the first party and/or the second party during a review period. The review period may be selected to provide a historical perspective of typical activity for the parties. The review period may be larger than the alert period. As an example, the review period may be set to 2 months and the alert period may be set to 3 consecutive business days. The method may detect that every day during the alert period, Party A transacted a transaction with Party B in an amount between $9,000 and $10,000 (e.g., just below a CRT reporting limit). The method may compare transactions between Party A and Party B during the review period, and may determine that the parties typically transact between $8,000 and $12,000 per day. Based on the historical perspective from the review period, the method may determine that the transaction amounts during the alert period are within typical ranges for the parties and that CRTs have been filed for the parties within the 2 month review period. As a result, the method may conclude the transactions during the alert period have a low risk of being structured. Thus, the review period may be set to any time period selected to provide suitable context to compare against the transactions that occur during the alert period. In some embodiments, the review period may be set to 1 month, 2 months, 6 months, 1 year, or other suitable time period. The review period may be configured to include transactions occurring before and/or after the transaction associated with potential alert 190.

At step 220, the method determines risk level 195 according to a plurality of weighting factors. Weighting factors may be applied so that increased risk is assigned to patterns of activity that are consistent with intent to structure transactions. Accordingly, risk level 195 may be used to efficiently detect structured transactions. Examples of weighting factors include a single transaction weighting factor, a frequency weighting factor, an average weighting factor, a total amount weighting factor, a location weighting factor, a non-reported transaction weighting factor, a reported transaction weighting factor, a take-back weighting factor, an even amount weighting factor, an excess consecutive transactions weighting factor, and an aggregate amount weighting factor, as discussed below. Any suitable number and combination of weighting factors may be used.

A single transaction weighting factor may decrease risk level 195 if a monetary amount of a transaction in the second subset satisfies a low-risk threshold. For example, the low-risk threshold may be set to a value inconsistent with payment structuring between the first party and the second party. As an example, the low-risk threshold could be set to $1,000,000 per single transaction. If the first party intends to disguise a large transaction to the second party by dividing it up into a series of smaller transactions, it may be unlikely that the first party would have transacted any large transaction (e.g., a $1,000,000 single transaction) with the second party during the review period. Thus, if the first party did transact a $1,000,000 single transaction with the second party during the review period, the risk may be decreased.

A frequency weighting factor may increase risk level 195 if a transaction frequency associated with the first subset of same party transactions exceeds a transaction frequency associated with the second subset of same party transactions by a first pre-determined factor (X). As an example, X may be set to 3.6 and the review period may be set to 2 months. The method may compare the average number of transactions between the first party and second party per day during the alert period to the average number of transactions between the first party and second party per day during the review period. For example, if the parties average 10 transactions per day during the alert period and 2 transactions per day during the review period, then risk level 195 may be increased (i.e., 10>3.6×2).

An average weighting factor may increase risk level 195 if an average monetary amount transacted between the parties per an averaging period during the alert period exceeds an average monetary amount transacted between the parties per the averaging period during the review period by a second pre-determined factor (Y). As an example, the averaging period could be one day, the review period could be 2 months, and Y could be 3. If the parties transacted $20,000 per day during the alert period and $5,000 per day during the review period, then risk level 195 may be increased (i.e., $20,000>3×$5,000). The average weighting factor may mitigate false positives caused by legitimate business practices that involve transactions occurring on a regular basis from the same originator to the same beneficiary, such as broker/dealer relationships or transactions between large corporate entities. In some embodiments, Y may be determined based on a percentile of potential alerts 190, such as the 25th percentile. In the example, this means Y may be set so that on average 25% of all potential alerts fail to meet the criterion and, therefore, receive an increased risk as a result of applying the average weighting factor.

A total amount weighting factor may increase risk level 195 if a total monetary amount transacted between the parties during the alert period exceeds a maximum individual monetary amount transacted between the parties during the review period by a third pre-determined factor (Z). The pre-determined factor Z may be set to any suitable number. In some embodiments, Z may be set to capture a certain percentile of transactions, such as the 90th percentile or the 95th percentile of potential alerts generated on originator/beneficiary pairs that have multiple transactions on the same or adjacent days. As an example, the 90th percentile may correspond to a Z factor of 3 and the 95th percentile may correspond to a Z factor of 4.

The total amount weighting factor may identify customers attempting to hide one large transaction by dividing it into multiple smaller transactions without unnecessarily identifying customers that are not attempting to hide large transactions. For example, suppose Party A wires $40,000 to Party B on each day during an alert period set to five consecutive business days, for a total of $200,000. This may ordinarily set off a payment layering alert. However, if during the review period Party A wires $150,000 to Party B in a single transaction, Party A and Party B do not exhibit a pattern of behavior consistent with hiding large transactions. The Z factor may be set such that the total amount weighting factor decreases risk level 195 for cases like this. As an example, Z may be set to 3. Accordingly, in the preceding example, the total monetary amount transacted between the parties during the alert period ($200,000) is less than $450,000 such that risk level 195 is decreased. In the example, the $450,000 corresponds to the Z factor (which is set to 3) times the maximum individual monetary amount transacted between the parties during the review period ($150,000).

A location weighting factor may increase risk level 195 if the first subset of same party transactions were initiated from more than a pre-determined number of locations. For example, if the pre-determined number of locations is set to three, the location weighting factor may increase risk level 195 if during the alert period Party A wires Party B $8,000 from a first banking center, $9,000 from a second banking center, and $9,500 from an online account, the location weighting factor may increase the risk.

A non-reported transaction weighting factor may increase risk level 195 if the monetary amount of one or more of the transactions in the first subset is greater than 80% and less than 100% of a reportable monetary amount. As an example, the reportable monetary amount may correspond to a CRT reporting limit ($10,000), such that the non-reported transaction weighting factor may increase risk level 195 for same party transactions between $8,000 and $10,000. The non-reported transaction weighting factor may facilitate identifying customers that conduct transactions in amounts slightly below the reporting limit because they intend to avoid having a report filed on the transaction. The non-reported transaction weighting factor may have any suitable percentage as the lower bound, such as 50%, 60%, 70%, 80%, 90%, 95%, or other percentage.

A reported transaction weighting factor may decrease risk level 195 if a recent transaction between the parties exceeded a reportable monetary amount. A recent transaction may refer to a transaction that occurred within a pre-determined recent time period, such as 1 week, 1 month, 2 months, or other suitable time period. If a report was recently filed on the parties, it suggests the parties do not intend to structure transactions to avoid reporting requirements.

A take-back weighting factor may increase risk level 195 associated with the first party if the first party cancelled a recent transaction that exceeded a reportable monetary amount, wherein the recent transaction occurred within a pre-determined recent time period. A recent transaction may refer to a transaction that occurred within a pre-determined recent time period, such as 1 week, 1 month, 2 months, or other suitable time period. As an example, a take-back may occur when a customer asks a bank teller to initiate a transaction, realizes that the a report will be filed on the transaction, and cancels the transaction to avoid the reporting limit. Canceling the transaction may refer to stopping the transaction or reducing the monetary amount so that it is less than the reporting limit. Take-back behavior suggests that the customer is avoiding the reporting limit.

An even amount weighting factor indicating to increase risk level 195 if a number of even amount transactions exceeds an even amount threshold, wherein the even amount transactions correspond to transactions in the first subset that have an associated monetary amount ending in a pre-determined number of zeros. This factor may identify transactions having “even” monetary amounts, such as amounts ending in at least two zeros (e.g., $8100, $9200, $10500), transactions ending in at least three zeros (e.g., $8000, $9000, $10000), or other monetary amounts ending in a pre-determined number of zeros. Parties that perform a certain number of even amount transactions may intend to break a large transaction into multiple smaller transactions. For example, it may be convenient for a party to divide an $18,000 transaction into three transactions in the amount of $9,000 each. This behavior would cause the even amount weighting factor to increase risk level 195, for example, if the pre-determined number of zeros was set to 3 (or fewer) zeros and the even amount threshold was set to 3 (or fewer) transactions. On the other hand, parties making multiple transactions in non-even amounts, such as $9,583.12, $8,972.34, and $9,413.29, may be more likely to be conducting legitimate business. This behavior would not cause the event amount weighting factor to increase risk level 195.

The excess consecutive transactions factor may increase risk level 195 if the number of transactions during a pre-determined consecutive time period exceeds a maximum consecutive transactions threshold. As an example, the pre-determined consecutive time period may correspond to the same business day or (n) number of consecutive business days (such as one business day) and the maximum consecutive transactions threshold could be set to 5. Thus, if the first party and the second party conduct at least five transactions on the same day or on two consecutive business days, risk level 195 may be increased.

In some embodiments, the maximum consecutive transactions threshold may be set to increase the risk associated with transactions in a certain percentile of possible potential alerts, such as the 90th percentile or the 95th percentile. As an example, the 90th percentile may correspond to 5 transactions with the same party during the consecutive time period, and the 95th percentile may correspond to 9 or more transactions with the same party during the consecutive time period. Thus, the 90th or 95th percentile may indicate an unusually large number of same party transactions compared to other customers and, thus, may indicate increased risk.

An aggregate amount weighting factor may decrease risk level 195 if the combined monetary amount of all the same party transactions during the alert period is less than a reporting limit. For example, if during the alert period the parties perform a total of two transactions in the amount of $4,000 each ($8,000 total) it is less likely that they intend to disguise a large transaction by dividing it into several smaller transactions. That is, even if the parties had transacted the $8,000 in a single transaction, the $10,000 CRT reporting limit would not have been met and no report would have been filed.

At step 224, the method communicates risk level 195. Risk level 195 may be communicated to an employee of a financial institution, an investigative business, or a governmental entity that monitors transactions to detect transaction structuring. Risk level 195 may be communicated in any suitable format. For example, risk level 195 may include a risk category (e.g., (high, medium, low) or (red, yellow, green) or (A, B, C)) and/or a numerical value indicating a level of risk. Risk level 195 may be communicated with any suitable information about the parties and/or transactions associated with risk level 195. In some embodiments, risk level 195 may be ranked with respect to risk levels associated with other transactions and/or other parties in order to prioritize risks and determine where further investigation is needed. In some embodiments, risk level 195 may be enriched according to human intelligence. For example, if a bank teller observes a customer behaving suspiciously, the bank teller can increase risk level 195. The method then ends.

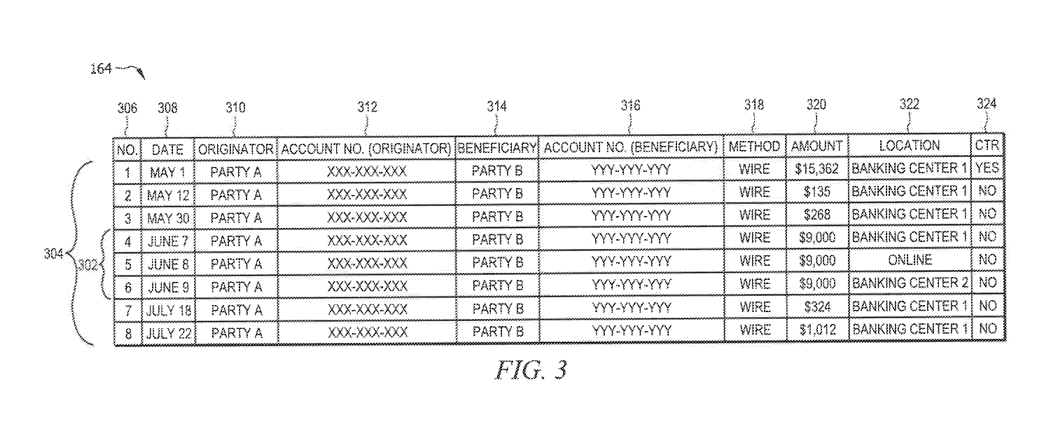

FIG. 3 illustrates an example of transaction history 164 that may be analyzed to determine whether the party (or parties) has demonstrated a pattern of activity consistent with transaction structuring. Transaction history 164 may include transactions occurring during an alert period 302 and during a review period 304. In the example, transaction no. 5 may correspond to the transaction that triggers a potential alert 190 on June 8. Alert period 302 may be configured to monitor transactions within one consecutive business day before and after transaction no. 5 (June 7 through June 9), and review period may be configured to monitor transactions within two months before and after transaction no. 5 (April 7 through August 7).

Each transaction listed in transaction history 164 may include a transaction number 206, the date of the transaction 308, an originator identifier 310 indicating the party that originated the transaction, an account number 312 associated with the originator identifier 310, a beneficiary identifier 314 indicating the party that was the beneficiary of the transaction, an account number 316 associated with the beneficiary identifier 314, a method of the transaction 316, a monetary amount 320, a location 322 where the transaction was initiated, a report indicator 324 indicating whether or not the transaction triggered the filing of a CRT or other report, and/or other suitable information.

Weighting factors may be applied to transaction history 164 to determine risk level 195. Risk level 195 may facilitate detecting unusual activity, such as potential transaction structuring, during alert period 302. As examples, in FIG. 3, the non-reported transaction weighting factor may be configured to increase the risk because the three transactions that occurred during alert period 302 were in the amount of $9,000 (just under the $10,000 CRT reporting limit), the even amount weighting factor may be configured to increase the risk because the three transactions each end in three zeros, and the location weighting factor may be configured to increase the risk because the three transactions were initiated form three separate locations (banking center 1, online, and banking center 2). Other weighting factors may apply depending on various implementations and configurations of the weighting factors.

Certain embodiments of the present disclosure may provide one or more technical advantages. A technical advantage of one embodiment includes applying weighting factors to transactions to identify customers with the intention of avoiding the filing of a CTR or other transaction report. The weighting factors may evaluate a relatively wide range of transactions, dates, and monetary amounts in order to improve the precision with which risks are identified. In particular, the weighting factors may target patterns of activity consistent with the intent to structure transactions to avoid reporting requirements. In addition, the weighting factors may suppress low-risk patterns of activity consistent with normal business activity. Thus, embodiments of the present disclosure may allow for efficient use of investigative resources, where resources are focused on high risk cases and not wasted on low risk cases. Certain embodiments of the present disclosure may include some, all, or none of the above advantages. One or more other technical advantages may be readily apparent to those skilled in the art from the figures, descriptions, and claims included herein.

Modifications, additions, or omissions may be made to the systems described herein without departing from the scope of the invention. The components may be integrated or separated. Moreover, the operations may be performed by more, fewer, or other components. Additionally, the operations may be performed using any suitable logic comprising software, hardware, and/or other logic. As used in this document, “each” refers to each member of a set or each member of a subset of a set.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure.

Although the present invention has been described in detail, it should be understood that various changes, substitutions, and alterations can be made hereto without departing from the scope of the invention as defined by the appended claims.

What is claimed is:

1. A system, comprising:
an interface operable to receive a potential alert associated with a transaction between two parties, the parties comprising a first party and a second party; and
one or more processors communicatively coupled to the interface, the one or more processors are operable to:
determine a first subset of same party transactions, the first subset comprising transactions between the parties during an alert period;
determine a second subset of same party transactions, the second subset comprising transactions between the parties during a review period; and
determine a risk level according to a plurality of weighting factors, wherein the weighting factors include:
a single transaction weighting factor indicating to decrease the risk level if a monetary amount of one of the transactions in the second subset satisfies a low-risk threshold;
a frequency weighting factor indicating to increase the risk level if a transaction frequency associated with the first subset of same party transactions exceeds a transaction frequency associated with the second subset of same party transactions by a first pre-determined factor (X);
an average weighting factor indicating to increase the risk level if an average monetary amount transacted between the parties per an averaging period during the alert period exceeds an average monetary amount transacted between the parties per the averaging period during the review period by a second pre-determined factor (Y); and
a total amount weighting factor indicating to increase the risk level if a total monetary amount transacted between the parties during the alert period exceeds a maximum individual monetary amount transacted between the parties during the review period by a third pre-determined factor (Z);
the interface further operable to communicate the risk level.

2. The system of claim 1, wherein the weighting factors further include a location weighting factor indicating to increase the risk level if the first subset of same party transactions were initiated from more than a pre-determined number of locations.

3. The system of claim 1, wherein the weighting factors further include a non-reported transaction weighting factor indicating to increase the risk level if the monetary amount of one or more of the transactions in the first subset is greater than 80% and less than 100% of a reportable monetary amount.

4. The system of claim 1, wherein the weighting factors further include a reported transaction weighting factor indicating to decrease the risk level if a recent transaction between the parties exceeded a reportable monetary amount, wherein the recent transaction occurred within a pre-determined recent time period.

5. The system of claim 1, wherein the weighting factors further include a take-back weighting factor indicating to increase the risk level associated with the first party if the first party cancelled a recent transaction that exceeded a reportable monetary amount, wherein the recent transaction occurred within a pre-determined recent time period.

6. The system of claim 1, wherein the weighting factors further include an even amount weighting factor indicating to increase the risk level if a number of even amount transactions exceeds an even amount threshold, wherein the even amount transactions corresponds to transactions in the first subset that have an associated monetary amount ending in a pre-determined number of zeros.

7. The system of claim 1, wherein the weighting factors further include an excess consecutive transactions factor indicating to increase the risk level if the number of transactions during a pre-determined consecutive timer period exceeds a maximum consecutive transactions threshold.

8. Non-transitory computer readable medium comprising logic, the logic, when executed by a processor, operable to:
receive a potential alert associated with a transaction between two parties, the parties comprising a first party and a second party;
determine a first subset of same party transactions, the first subset comprising transactions between the parties during an alert period;
determine a second subset of same party transactions, the second subset comprising transactions between the parties during a review period;
determine a risk level according to a plurality of weighting factors, wherein the weighting factors include:
a single transaction weighting factor indicating to decrease the risk level if a monetary amount of one of the transactions in the second subset satisfies a low-risk threshold;
a frequency weighting factor indicating to increase the risk level if a transaction frequency associated with the first subset of same party transactions exceeds a transaction frequency associated with the second subset of same party transactions by a first pre-determined factor (X);
an average weighting factor indicating to increase the risk level if an average monetary amount transacted between the parties per an averaging period during the alert period exceeds an average monetary amount transacted between the parties per the averaging period during the review period by a second pre-determined factor (Y); and
a total amount weighting factor indicating to increase the risk level if a total monetary amount transacted between the parties during the alert period exceeds a maximum individual monetary amount transacted between the parties during the review period by a third pre-determined factor (Z); and
communicate the risk level.

9. The computer readable medium of claim 8, wherein the weighting factors further include a location weighting factor indicating to increase the risk level if the first subset of same party transactions were initiated from more than a pre-determined number of locations.

10. The computer readable medium of claim 8, wherein the weighting factors further include a non-reported transaction weighting factor indicating to increase the risk level if the monetary amount of one or more of the transactions in the first subset is greater than 80% and less than 100% of a reportable monetary amount.

11. The computer readable medium of claim 8, wherein the weighting factors further include a reported transaction weighting factor indicating to decrease the risk level if a recent transaction between the parties exceeded a reportable monetary amount, wherein the recent transaction occurred within a pre-determined recent time period.

12. The computer readable medium of claim 8, wherein the weighting factors further include a take-back weighting factor indicating to increase the risk level associated with the first party if the first party cancelled a recent transaction that exceeded a reportable monetary amount, wherein the recent transaction occurred within a pre-determined recent time period.

13. The computer readable medium of claim 8, wherein the weighting factors further include an even amount weighting factor indicating to increase the risk level if a number of even amount transactions exceeds an even amount threshold, wherein the even amount transactions corresponds to transactions in the first subset that have an associated monetary amount ending in a pre-determined number of zeros.

14. A method, comprising:
receiving a potential alert associated with a transaction between two parties, the parties comprising a first party and a second party;
determining a first subset of same party transactions, the first subset comprising transactions between the parties during an alert period;
determining a second subset of same party transactions, the second subset comprising transactions between the parties during a review period;
determining, by one or more processors, a risk level according to a plurality of weighting factors, wherein the weighting factors include:
a single transaction weighting factor indicating to decrease the risk level if a monetary amount of one of the transactions in the second subset satisfies a low-risk threshold;
a frequency weighting factor indicating to increase the risk level if a transaction frequency associated with the first subset of same party transactions exceeds a transaction frequency associated with the second subset of same party transactions by a first pre-determined factor (X);
an average weighting factor indicating to increase the risk level if an average monetary amount transacted between the parties per an averaging period during the alert period exceeds an average monetary amount transacted between the parties per the averaging period during the review period by a second pre-determined factor (Y); and
a total amount weighting factor indicating to increase the risk level if a total monetary amount transacted between the parties during the alert period exceeds a maximum individual monetary amount transacted between the parties during the review period by a third pre-determined factor (Z); and
communicating the risk level.

15. The method of claim 14, wherein the weighting factors further include a location weighting factor indicating to increase the risk level if the first subset of same party transactions were initiated from more than a pre-determined number of locations.

16. The method of claim 14, wherein the weighting factors further include a non-reported transaction weighting factor indicating to increase the risk level if the monetary amount of one or more of the transactions in the first subset is greater than 80% and less than 100% of a reportable monetary amount.

17. The method of claim 14, wherein the weighting factors further include a reported transaction weighting factor indicating to decrease the risk level if a recent transaction between the parties exceeded a reportable monetary amount, wherein the recent transaction occurred within a pre-determined recent time period.

18. The method of claim 14, wherein the weighting factors further include a take-back weighting factor indicating to increase the risk level associated with the first party if the first party cancelled a recent transaction that exceeded a reportable monetary amount, wherein the recent transaction occurred within a pre-determined recent time period.

19. The method of claim 14, wherein the weighting factors further include an even amount weighting factor indicating to increase the risk level if a number of even amount transactions exceeds an even amount threshold, wherein the even amount transactions corresponds to transactions in the first subset that have an associated monetary amount ending in a pre-determined number of zeros.

20. The method of claim 14, wherein the weighting factors further include an excess consecutive transactions factor indicating to increase the risk level if the number of transactions during a pre-determined consecutive timer period exceeds a maximum consecutive transactions threshold.
